(19) United States
(12) Patent Application Publication
(10) Pub. No.: US 2012/0284755 A1
(43) Pub. Date: Nov. 8, 2012

(54) DEVICE, SYSTEM AND METHOD OF TELEVISION BROADCASTING OF LIVE FEED FROM MOBILE DEVICES

(75) Inventors: Samuel Keret, Kiryat Ono (IL); Uri Levine, Kfar Saba (IL); Amir Shinar, Moshav Ein-Vered (IL); Ehud Shabtai, Tel-Aviv (IL); Yuval Shmuelevitz, Ramat Hasharon (IL)

(73) Assignee: WAZE, INC., Palo Alto, CA (US)

(21) Appl. No.: 13/432,992

(22) Filed: Mar. 28, 2012

Related U.S. Application Data
(60) Provisional application No. 61/457,437, filed on Mar. 28, 2011.

(51) Int. Cl. H04N 21/60; G06F 17/00

(52) U.S. Cl. 725/62; 715/234

(57) ABSTRACT

Embodiments of the present invention are directed toward a device, system and method of television broadcasting of live feed from mobile devices. A client application residing on a mobile device allows a user of the mobile device to provide real-time reporting of an event to a central location which is configured to broadcast such live feed. A broadcaster is able to invite a user to provide the live feed. In addition or alternatively, a user is able to propose to the broadcaster that the user, who is located in proximity of a news-worthy event, is willing to commence a live feed. The broadcaster is able to accept or reject the proposal, and modify or negotiate the terms of the transfer of the live feed. The live feed is typically incorporated substantially in real time within a live broadcast.

### RELATED APPLICATIONS

This application claims benefit of priority under 35 U.S.C. section 119(e) of the co-pending U.S. Provisional Patent Application Ser. No. 61/457,437 filed Mar. 28, 2011, entitled “Device, System, and Method of Television Broadcasting of Live Feed from Mobile Devices,” which is hereby incorporated by reference in its entirety.

### FIELD OF THE INVENTION

The present invention is related to the field of wireless communication. More specifically, the present invention relates to device, system, and method of television broadcasting of live feed from mobile devices.

### BACKGROUND OF THE INVENTION

Cellular phones, smart-phones, tablet devices, and other portable devices allow a user to accomplish a variety of tasks while being away from the user's home or office. Such tasks include, for example, engaging in voice conversation, video conferencing, playback of audio clips and video clips, viewing of photographs and images, exchanging Instant Messaging (IM) messages with other users, sending and receiving Electronic Mail (Email), or the like.

Some portable devices, as well as some vehicular devices or dashboard devices, are equipped with a General Positioning System (GPS) component or other suitable components, which allow the user to engage in certain Location-Based Services (LBS), to obtain a map corresponding to a current location of the user, to obtain a driving route from a first location to a second location, to obtain route guidance information for traveling from a first location to a second location, or the like.

### SUMMARY OF THE INVENTION

Embodiments of the present invention are directed toward a device, system and method of television broadcasting of live feed from mobile devices. A client application residing on a mobile device allows a user of the mobile device to provide real-time reporting of an event to a central location which is configured to broadcast such live feed. A broadcaster is able to invite a user to provide the live feed. In addition or alternatively, a user is able to propose to the broadcaster that the user, who is located in proximity of a news-worthy event, is willing to commence a live feed. The broadcaster is able to accept or reject the proposal, and modify or negotiate the terms of the transfer of the live feed. The live feed is typically incorporated substantially in real time within a live broadcast.

In one aspect, a mobile device includes a processor and an application executed by the processor. The application is configured to provide a live feed to a broadcaster. The live feed is of audio, video, text or a combination thereof. The broadcaster, which can be a television broadcaster or a radio broadcaster, is typically configured to broadcast the live feed received from the mobile device to one or more receiving devices.

In some embodiments, communication between the mobile device and the broadcaster is initiated by the broadcaster, wherein the mobile device receives an invitation or request from the broadcaster to provide the live feed from the mobile device. Alternatively, communication between the mobile device and the broadcaster is initiated by the mobile device, wherein the mobile device signals to the broadcaster that a user of the mobile device is willing to commence the live feed to the broadcaster. In some embodiments, the application is configured to commence the live feed to the broadcaster from the mobile device.

The mobile device can be a cellular phone, a Personal Digital Assistant (PDA) device, a smart-phone, a Portable Navigation Device (PND), a mobile route guidance device, a mobile mapping device, a mobile traffic updates device, a portable audio player, a portable video player, or a portable audio/video player.

In another aspect, a server device includes a processor and an application executed by the processor. The application is configured to receive live feed from at least one user and to incorporate the live feed into broadcasting. Typically, the live feed is incorporated into the broadcasting in substantially real time. However, the live feed can be incorporated into the broadcasting with a pre-defined intentional delay. In some embodiments, the server device is configured to send an invitation to the at least one user to provide the live feed from a mobile device that is in the possession of the at least one user.

In yet another aspect, a system includes at least one client device and a server communicatively coupled with the at least one client device. The at least one client device configured to provide a live feed. The server typically includes a broadcaster component configured to perform broadcasting of the live feed to at least one receiving device. In some embodiments, the at least one receiving device is configured to receive the live feed via at least one of cable, satellite and RF transmission.

In some embodiments, the server further includes a transcoder/converter component. The transcoder/converter component is configured to transcode/convert the live feed into a suitable format for broadcasting.

In some embodiments, the server further includes a data store. The data store is configured to store personal information provided during registration of a user associated with the at least one client device, and to store real-time location information of the at least one client device. The data store is also configured to store data collected and aggregated by the system.

In some embodiments, the server further includes a mapping module. The mapping module is configured to generate a digital representation of at least one geographical map.

In some embodiments, the system further includes at least one web server that hosts one or more web sites, which include a supervisor-oriented website, a user-oriented website or both.

In yet another aspect, a web page includes a map area and a user profile area. The map area typically includes a graphical representation of a set of roads and of a location of an event of interest. An event of interest can be an event that is suitable for news reporting, such as an accident. The user profile area is typically configured to dynamically display data associated with a user when a corresponding graphical representation of the user displayed in the map area is activated. Typically, movement of the user in the real world corresponds to movement of the corresponding graphical representation of the user in the map area. In some embodiments, the user profile area includes a contact feature configured to provide communication with the user.

For example, a viewer of the web page is able to initiate communication with the user in order to invite the user to provide live audio/video/text feed from the user's mobile device.

In some embodiments, the web page further includes a user interface configured to calibrate the map area.

In some embodiments, the web page further includes a radius selection interface configured to allow the viewer to select a radius such that a map of an area within the radius around the location of the event of interest is shown.

In some embodiments, the web page further includes a number-of-cars selection interface configured to allow the viewer to select a maximum value for a number of users that are to be displayed within the map area. The number-of-cars selection interface is configured to allow the viewer to specify displaying criteria, including rating or score, number of previous broadcasts, etc.

### BRIEF DESCRIPTION OF THE DRAWINGS

Reference will now be made in detail to implementations of the present invention as illustrated in the accompanying drawings. The same reference indicators will be used throughout the drawings and the following detailed description to refer to the same or like parts.

FIG. 1 illustrates a schematic block-diagram of a user-oriented website in accordance with some embodiments.

FIG. 2 illustrates a schematic block-diagram of a supervisor-oriented website in accordance with some embodiments.

FIG. 3 illustrates a schematic block-diagram of a system in accordance with some embodiments.

FIG. 4 illustrates a schematic block-diagram of a supervisor-oriented website in accordance with some embodiments.

### DETAILED DESCRIPTION OF THE INVENTION

In the following detailed description, numerous specific details are set forth in order to provide a thorough understanding of some embodiments. However, it will be understood by persons of ordinary skill in the art that some embodiments is able to be practiced without these specific details. In other instances, well-known methods, procedures, components, units and/or circuits have not been described in detail so as not to obscure the discussion.

Embodiments of the present invention are directed toward a device, system and method of television broadcasting of live feed from mobile devices. Some embodiments of the present invention include a communication system which allows live reporting, real-time reporting, substantially live reporting, and/or substantially real-time reporting of events as a “live feed” by one or more users of wireless communication devices to a central location. The central location is able to, in turn, substantially simultaneously broadcast such live feed as a television broadcast, e.g., through cable television, satellite or dish television, or Radio Frequency (RF) transmission based television broadcast. The present invention advantageously allows an “eyewitness news” type of broadcasting from mobile devices to live television. Some embodiments of the present invention utilize a sub-system of wireless communication devices, which is able to interface with a sub-system of television broadcasting. It should be recognized that the invention is herein described relative to television broadcasts. However, the invention can be applied to other types of broadcasts, including radio broadcasts.

A community of users of mobile devices is able to be associated with a particular television channel or station or program (e.g., eyewitness news mobile user community, or other television broadcaster mobile user community). A mobile device of such a user typically includes a particular application or client-side software that allows the user to register in advance as a potential driver, traveler, eyewitness and/or reporter associated with that television broadcaster. Typically, the application is retrievable and downloadable from a source location. In some embodiments, only pre-registered users are able to provide live feed to the television broadcaster, which incorporates such live feed, incoming from such mobile devices, substantially in real time within a live television broadcast (e.g., occupying the entire television screen, or a selected portion or window within the television screen). Alternatively, users who simply have such an application on their mobile devices are able to provide live feed to the television broadcaster.

For example, assume a user of the eyewitness news mobile user community is traveling or driving. Once the user sees or notices an event, which is suitable for news reporting (e.g., an accident, a fire, a flood, a terror attack), the user is able to turn into a live reporter for broadcast television by utilizing the user's mobile device.

In some embodiments, the television broadcaster is able to query the system to find out which particular users are currently located in proximity to a particular location-of-interest, in which a news-worthy event is possibly occurring. The television broadcast is able to then initiate communication with such selected users to invite them to provide live audio/video/text feed from their mobile devices to the television broadcaster, with or without such users' additional commentaries in the background.

Alternatively or in addition to, a user is able to initiate the communication with the television broadcaster, by utilizing the user's mobile device, the particular application in the mobile device, or by other suitable ways, e.g., by sending a text message or an email message to the television broadcaster, or by otherwise signaling the television broadcaster that the mobile device user is located in proximity to a news-worthy event, and that the mobile device user is willing to commence a live feed of audio, video and/or text from the event scene to the television broadcaster.

Once the television broadcaster receives such proposal from the mobile device user, the television broadcaster can accept or reject the proposal from the mobile device user to transfer live feed of audio, video and/or text from the event scene. The television broadcaster can also modify or negotiate the terms of such transfer of live feed (e.g., the user is able to propose to transfer a live feed of audio, and the television broadcaster is able to respond to the user with a request to transfer a live feed of both audio and video, or vice versa).

The live feed received from one or more users of mobile devices is incorporated into television broadcasting, either in real time, or substantially in real time, or in real time but can be subject to a pre-defined intentional delay (e.g., a seven seconds delay) in order to allow the television broadcaster to close or mute or pause the television broadcast of the live feed if the live feed includes audio, video and/or text segments that are not suitable for broadcasting on television for various reasons.

Some embodiments of the present invention allow integration and interactive communication between a television broadcaster (e.g., a news channel) and one or more users of mobile devices who are not, by themselves, professional news reporters but who happen to be located in proximity to a news-worthy event or scene.

Embodiments of the present invention can thus advantageously eliminate or reduce the response time of a news channel to a news-worthy event. For example, instead of sending a news broadcasting vehicle to the event scene, which can take a long period of time to arrive at the scene (e.g., particularly since roads is able to be closed or blocked due to the event taking place), the news channel is able to directly communicate with nearby users of mobile devices, and is able to obtain within seconds live feed or live footage of audio, video and/or text of such event or scene.

In some embodiments, a route guidance system, a navigation system and/or a traffic alerts system is able to have a community of users of mobile devices. Typically, the users are able to wirelessly transmit to a central server updated data about current situations on various roads (e.g., traffic congestion, hazards, accidents, or the like), together with data indicating the exact or proximate geo-spatial location of each such mobile device.

All users are able to register to a system of “eyewitness news reporting” and, by doing so, the users allow authorized personnel, such as a system supervisor at the television broadcaster, to view and know their respective locations, substantially in real time. Such registered users also allow the system supervisor at the television broadcaster to selectively or collectively contact them via communication means to propose to them to go live in television broadcasting through their mobile devices and/or in order to interview them as a witness on the scene. Exemplary communication means include phone, instant text messaging, video chat, electronic mail and the like.

Once the system supervisor receives an indication of a news-worthy event, the system supervisor is able to dispatch a news reporting crew to that scene and, in parallel, while the news reporting crew is on its way to the event scene, the system supervisor is able to view a computerized representation of a geographical map which shows indications of registered users of mobile devices that are located near that scene location. The system supervisor is able to select one or more of such users, in order to interview them on television through their mobile devices, and/or in order to obtain from them live audio feed, live video feed, live audio/video feed, captured audio footage, captured video footage, captured audio/video footage, captured photographs, real-time audio commentary from such users, or other user input, including but not limited to text, which is able to then be incorporated by the television broadcaster in live television broadcasting to millions of users nationwide or worldwide.

In some embodiments, the system supervisor is able to select the best or optimal user for reporting on an event, out of a group of users which are located at approximately the same distance or within a predetermined distance from the scene of interest. A data store at and/or accessible by the television broadcaster is configured to store data about each such user, including data that the user provided during the registration process (e.g., age, gender, profession, home address, level of education, knowledge of particular language, or the like) and/or data that the system is able to collect and aggregate by itself (e.g., history of previous reporting by the user; comments or feedback or rating that various members of the television broadcaster wrote about the user).

For example, the system supervisor is able to select, out of a group of nearby users, a particular user that speaks a particular language (e.g., Spanish) in order to provided details about a particular news events which involves natives of such language (e.g., to describe a demonstration by Spanish-speaking people).

For another example, the system supervisor is able to select, out of a group of nearby users, a particular user that belongs to a certain profession or occupation (e.g., a nurse, or a student) in order to provided details about a particular news events which involves particular type of persons. Other suitable criteria and user attributes can be used (and are available to the system supervisor through a control interface, which is discussed in detail elsewhere) in order to select a more-suitable user for live-television reporting through a mobile device.

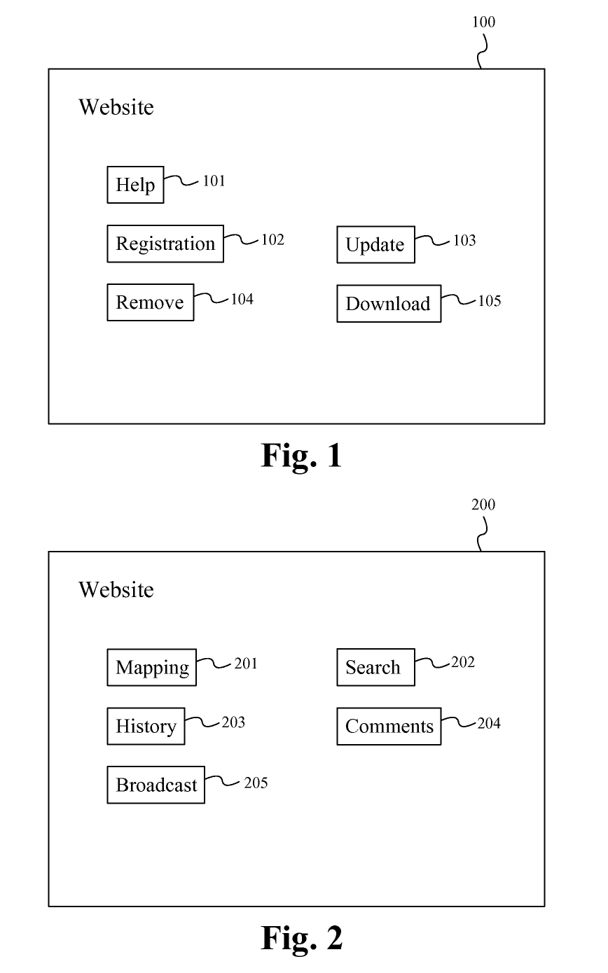

FIG. 1 illustrates a schematic block-diagram of a user-oriented website 100 in accordance with some embodiments. The dedicated and secure website 100 is typically provided and accessible for the purpose of implementing portions of the system. In some embodiments, the website 100 includes an informative video clip and/or other help components 101, which provide information to prospective users who are considering downloading a client-side software or application and/or registering for the service.

Alternatively or in addition to, the website 100 includes a registration form 102 that can be filled-out by a user in order to register for the service. The registration form 102 can include various personal details. Personal details include, but are not limited to, first name, last name, age, gender, profession, city of residence, phone number, email address, photograph of the user, indication of the mobile phone of the user or indication of multimedia capabilities of such mobile phone, languages spoken by the user, details of a vehicle associated with the user (e.g., in order to allow the news reporting team of the television broadcaster, once they arrive at the event scene, to rapidly locate the eyewitness user for further interviews), and the like.

Alternatively or in addition to, the website 100 includes an update form or an update interface 103 to allow a user to modify or update personal information that the user provided in the initial registration process. The website 100 is able to indicate a last modified date associated with the previously provided personal information.

Alternatively or in addition to, the website 100 includes a removal interface 104 to allow a user to delete, remove, suspend or de-activate his or her registration, including the option to temporarily suspend the user's registration for a limited period of time (e.g., if the user anticipates that in the upcoming week, due to personal obligations, the user is able to not be available to act as an eyewitness news reporter).

Alternatively or in addition to, the website 100 includes other suitable links, for example, download links 105 to allow users to access and download the client-side software or application.

FIG. 2 illustrates a schematic block-diagram of a supervisor-oriented website 200 in accordance with some embodiments. In some embodiments, the website 200 is separate from the website 100 of FIG. 1, for example, by residing on a different server or a different Internet domain name or DNS address. Alternatively, the website 200 is optionally implemented as a secure portion or secure web-page or an access-controlled web-page within the website 100. In some embodiments, the website 200 is accessible only by authorized personnel of the television broadcaster who are required to enter username and password combination to authenticate their identity.

The website 200 includes a mapping component 201 to allow the system supervisor to view a map showing representations of the current geo-spatial locations of the registered users. In some embodiments, the website 200 includes an interface to allow generation of a map showing representation of current locations of registered mobile users, with or without additional details (e.g., name, age, or other attributes) displayed in proximity to such location indications.

In addition or alternatively, the website 200 includes a search interface 202 to allow, for example, the system supervisor to search for a particular number of users (e.g., 12 users) that are located within a particular distance (e.g., within 85 meters) of a particular location (e.g., the Empire State Building, or a particular street address) and to further refine the search based on, for example, language (e.g., Spanish).

Alternatively or in addition to, the website 200 allows the system supervisor to review history 203 (e.g., past activity) of mobile users and/or to review (and optionally augment or modify) comments 204 or notes or scores or ratings about such mobile users.

Alternatively or in addition to, the website 200 includes a broadcast component 205 configured to present a map or portions thereof in a separate tab or window that is more suitable for broadcasting on television.

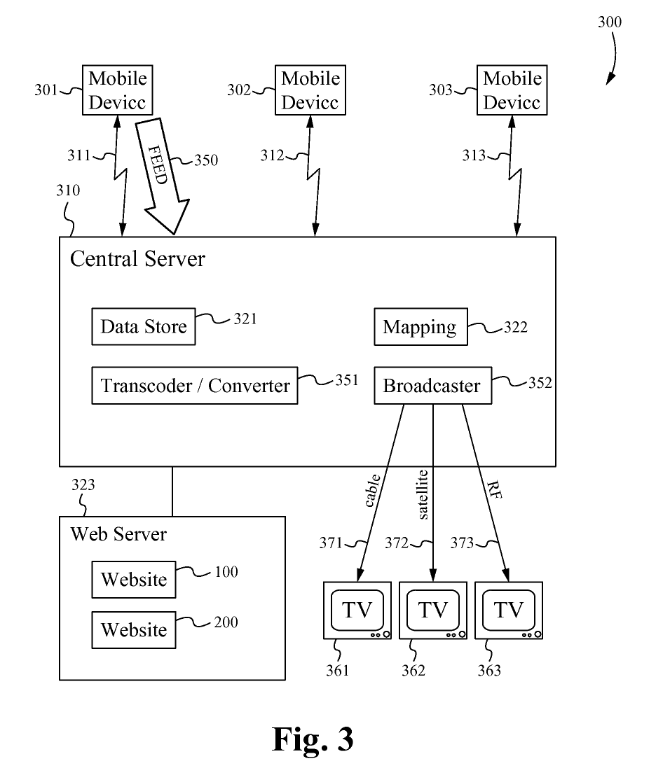

FIG. 3 illustrates a schematic block-diagram of a system 300 in accordance with some embodiments. The system 300 includes one or more mobile devices 301-303 and a central server 310. The mobile devices 301-303 are configured to communicate wirelessly with the central server 310, by using wireless communication links 311-313, respectively.

The central server 310 includes a data store module 321 configured to store data about each mobile device 301-303, as well as data about current location of each such mobile device 301-303. The data store module 321 can include one or more databases. The central server 310 also includes a mapping module 322 configured to generate a digital representation of a geographical map, and performs zoom-in, zoom-out and scroll operations with regard to such map.

The system 300 includes one or more web-server(s) 323. The web-server(s) 323 are coupled with the central server 310 and are configured to host the user-oriented website 100 of FIG. 1 and/or the supervisor-oriented website 200 of FIG. 2.

The system 300 also includes suitable components to allow the central server 310 to receive a live feed 350 (e.g., an audio/video/text feed) from a mobile device 301-303. For example, the central server 310 includes a transcoder/converter 351 and a broadcasting component 352. The transcoder/converter 351 is configured to transcode and/or convert the received live feed into a format suitable for television broadcasting. The broadcasting component 352 is configured to perform the television broadcasting of the live feed to multiple receiving devices (e.g., television devices) 361-363, for example, by cable 371, via satellite 372, and/or via RF transmission 373.

In some embodiments, the system 300 includes a synchronizer. The synchronizer is configured to automatically create, at pre-defined time intervals (e.g., every hour, or every day), a user database file. The user database file typically includes a list of registered users (namely, users of mobile devices that registered to act as potential eyewitness news reporters) and their respective details. This file, and optionally associated photographs of users, is sent to the television broadcaster (e.g., daily or hourly). The file is able to assist the system supervisor to locate mobile device users who live near a particular scene in case there are no registered users who are currently located in proximity to the event scene. In some embodiments, the file can be further updated manually, for example, to reflect comments and/or history per mobile device user.

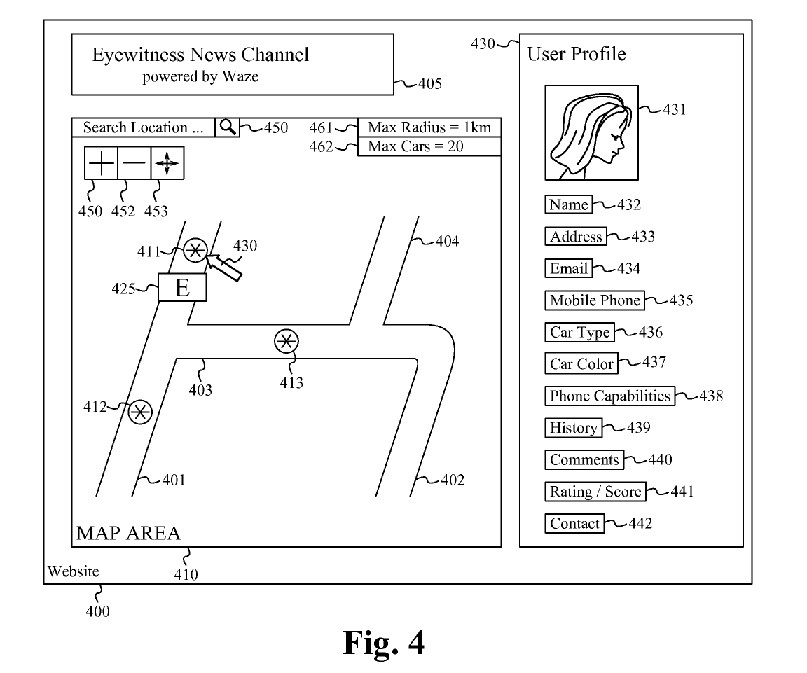

FIG. 4 illustrates a schematic block-diagram of a supervisor-oriented website 400 in accordance with some embodiments. The website 400 can be a demonstrative implementation, or a web page, of the website 200 of FIG. 2.

In some embodiments, the website 400 includes a banner or logo 405 indicating that this website 400 is associated with a particular television broadcaster and/or a particular service provider (e.g., a co-branded banner of logo, optionally showing familiar faces of news anchorpersons).

The website 400 typically includes a dynamic map area 410 and a user profile area 430 which is able to dynamically adapt its content based on clicking or hovering of a cursor or pointer 430 (e.g., a mouse pointer or other interface pointer) within the map area 410. The map area 410 typically includes a graphical representation of a set of roads or routes 401-404, as well as graphical representations of the geo-spatial locations of registered users of mobile devices 411-413 (shown with an asterisk character in FIG. 4). Upon movement of a user in the real world, the corresponding graphical representation is able to move within the map area 410. The map area 410 also include a graphical representation of a geo-spatial location of an event-of-interest 425 (shown with the character “E” in FIG. 4).

Alternatively or in addition to, the map area 410 includes a user interface 450 (e.g., a query field and a “search” button) configured to calibrate the map area 410. For example, the user interface 450 is able to command the system to show a portion of a map which is around a particular geo-spatial location, e.g., by indicating the graphical coordinates of the location of the event-of-interest 425. The map area 410 can also further include a zoom interface, for example, a zoom-in button 451 and a zoom-out button 452. The map area 410 is scroll-able or drag-able by a viewer, either as a default or in response to the viewer clicking on a “drag map” button 453 or other map-scrolling interface.

Alternatively or in addition to, the map area 410 includes a radius selection interface 461 configured to allow the viewer (e.g., system supervisor) to input or select a radius (e.g., one kilometer, 300 meters, 2400 meters, or the like), such that the map area 410 shows, in response to such selection, only graphical representation of a map which is within such radius around the location of the event-of-interest 425, and/or such that the map area 410 shows, in response to such selection, the locations of mobile devices 411-413 which are located within such radius around the location of the event-of-interest 425.

Alternatively or in addition to, the map area 410 includes a number-of-cars selection interface 462 configured to allow the viewer to input or select a maximum value for the number of cars or mobile devices that are to be displayed within the map area 410 (e.g., ten users, 27 users, or the like). In some embodiments, the map area 410 shows, in response to such selection of the number-of-cars denoted as K, only graphical representations of the K users which are the closest to the location of the event-of-interest 425, even if there are more than K users who are within the range of the map area 410. In some embodiments, the interface allows the viewer to command that such K cars to be displayed be selected based on other one or more criteria, such as, by picking the K users having the highest rating or score, or having the highest number of previous broadcasts, or by picking K users that have comments associated with them, or other suitable combinations of selection criteria.

In some embodiments, the viewer is able to utilize the cursor or pointer 430 in order to click or hover on or otherwise activate a graphical representation of a mobile device, e.g., mobile device 411. In response, the user profile area 430 is dynamically loaded and displayed or populated with data associated with that mobile device 411, for example: a photograph 431; a name 432; a home address 433 (or, at least, city or residence); an email address 434; a mobile phone number 435; car type data 436 (e.g., car brand, car model); car color data 437; mobile phone capabilities data 438 (e.g., indicating that the mobile phone is capable of wireless communication in accordance with cellular 3G or 4G protocols; capable of capturing video; pixel resolution of the camera of the mobile device); history data 439 (e.g., indicating that this particular mobile device had already provided past broadcasts, with details about their dates, times, length of time, and report type, e.g., video or audio); comments 440 (e.g., entered by system administrators, indicating that the user of this mobile device is very talkative and likes to report, or is proficient in a particular language, or has a particular accent); and/or data indicating a rating or a score 411 associated with that mobile device user (e.g., a rating of stars in a scale of zero to five, indicating reliability or quality of reports by that user). Other suitable data items about the user is able to be shown and/or updated. Alternatively or in addition to, the user profile area 430 includes an invite feature 442 which allows the viewer to invite or otherwise communicate with the user via a phone call, an email, a text message, a chat or other communication means to provide live audio/video/text feed from their mobile devices to the television broadcaster.

The terms “plurality” or “a plurality” as used herein include, for example, “multiple” or “two or more.” For example, “a plurality of items” includes two or more items.

Although portions of the discussion herein relate, for demonstrative purposes, to wired links and/or wired communications, some embodiments are not limited in this regard, and is able to include one or more wired or wireless links, is able to utilize one or more components of wireless communication, is able to utilize one or more methods or protocols of wireless communication, or the like. Some embodiments is able to utilize wired communication and/or wireless communication.

Some embodiments is able to be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry, iPhone, iPad, iPod, iPod Touch, an Android device), a Wireless Application Protocol (WAP) device, or the like.

Some embodiments is able to be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3GPP Long Term Evolution (LTE), 3.5G, 4G, or the like. Some embodiments is able to be used in conjunction with various other devices, systems and/or networks.

The terms “wireless device,” “wireless computing device,” “mobile device” or “mobile computing device” as used herein include, for example, a device capable of wireless communication, a communication device or communication station capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like.

The term “user” as used herein includes, for example, a person or entity that owns a computing device or a wireless device; a person or entity that operates or utilizes a computing device or a wireless device; or a person or entity that is otherwise associated with a computing device or a wireless device.

Some embodiments is able to utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof.

Other suitable operations or sets of operations is able to be used in accordance with some embodiments. Some operations or sets of operations is able to be repeated, for example, substantially continuously, for a pre-defined number of iterations, or until one or more conditions are met. In some embodiments, some operations is able to be performed in parallel, in sequence, or in other suitable orders of execution

Discussions herein utilizing terms such as, for example, “processing,” “computing,” “calculating,” “determining,” “establishing,” “analyzing,” “checking,” or the like, is able to refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that is able to store instructions to perform operations and/or processes.

Some embodiments is able to take the form of an entirely hardware embodiment, an entirely software embodiment, or an embodiment including both hardware and software elements. Some embodiments is able to be implemented in software, which includes but is not limited to firmware, resident software, microcode, or the like.

Furthermore, some embodiments is able to take the form of a computer program product accessible from a computer-usable or computer-readable medium providing program code for use by or in connection with a computer or any instruction execution system. For example, a computer-usable or computer-readable medium or article or storage article is able to be or is able to include any apparatus that can contain, store, communicate, propagate, or transport the program for use by or in connection with the instruction execution system, apparatus, or device.

In some embodiments, the medium or article is able to be or is able to include an electronic, magnetic, optical, electromagnetic, InfraRed (IR), or semiconductor system (or apparatus or device) or a propagation medium. Some demonstrative examples of a computer-readable medium is able to include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk—Read-Only Memory (CD-ROM), Compact Disk—Read/Write (CD-R/W), DVD, or the like.

In some embodiments, a data processing system suitable for storing and/or executing program code is able to include at least one processor coupled directly or indirectly to memory elements, for example, through a system bus. The memory elements is able to include, for example, local memory employed during actual execution of the program code, bulk storage, and cache memories which is able to provide temporary storage of at least some program code in order to reduce the number of times code must be retrieved from bulk storage during execution.

In some embodiments, input/output or I/O devices (including but not limited to keyboards, displays, pointing devices, etc.) is able to be coupled to the system either directly or through intervening I/O controllers. In some embodiments, network adapters is able to be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components is able to be used.

Some embodiments is able to be implemented by software, by hardware, or by any combination of software and/or hardware as is able to be suitable for specific applications or in accordance with specific design requirements. Some embodiments is able to include units and/or sub-units, which is able to be separate of each other or combined together, in whole or in part, and is able to be implemented using specific, multi-purpose or general processors or controllers. Some embodiments is able to include buffers, registers, stacks, storage units and/or memory units, for temporary or long-term storage of data or in order to facilitate the operation of particular implementations.

Some embodiments is able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, is able to be combined with, or is able to be utilized in combination with, one or more other functions, operations, components and/or features described herein with reference to one or more other embodiments, or vice versa.

While certain features of some embodiments have been illustrated and described herein, many modifications, substitutions, changes, and equivalents is able to occur to those skilled in the art. Accordingly, the following claims are intended to cover all such modifications, substitutions, changes, and equivalents.

We claim:

1. A mobile device comprising:
a. a processor; and
b. an application executed by the processor, the application configured to provide a live feed to a broadcaster configured to broadcast the live feed to one or more receiving devices.

2. The mobile device of claim 1, wherein the broadcaster is one of television broadcaster and radio broadcaster.

3. The mobile device of claim 1, wherein the live feed is of at least one of audio, video and text.

4. The mobile device of claim 1, wherein communication between the mobile device and the broadcaster is initiated by the broadcaster, wherein the mobile device receives an invitation from the broadcaster to provide the live feed from the mobile device.

5. The mobile device of claim 1, wherein communication between the mobile device and the broadcaster is initiated by the mobile device, wherein the mobile device signals to the broadcaster that a user of the mobile device is willing to commence the live feed to the broadcaster.

6. The mobile device of claim 1, wherein the application is configured to commence the live feed to the broadcaster from the mobile device.

7. The mobile device of claim 4, wherein the mobile device a device selected from the group consisting of a cellular phone, a Personal Digital Assistant (PDA) device, a smart-phone, a Portable Navigation Device (PND), a mobile route guidance device, a mobile mapping device, a mobile traffic updates device, a portable audio player, a portable video player, and a portable audio/video player.

8. A server device comprising:
a. a processor; and
b. an application executed by the processor, the application configured to:
1. receive live feed from at least one user; and
2. incorporate the live feed into broadcasting.

9. The server device of claim 8, wherein the live feed is incorporated into the broadcasting in substantially real time.

10. The server device of claim 8, wherein the live feed is incorporated into the broadcasting with a pre-defined intentional delay.

11. The server device of claim 8, wherein the server device is configured to send an invitation to the at least one user to provide the live feed from a mobile device in the possession of the at least one user.

12. A system comprising:
a. at least one client device configured to provide a live feed; and
b. a server communicatively coupled with the at least one client device, wherein the server includes a broadcaster component configured to perform broadcasting of the live feed to at least one receiving device.

13. The system of claim 12, wherein the at least one receiving device is configured to receive the live feed via at least one of cable, satellite and RF transmission.

14. The system of claim 12, wherein the server further comprises a transcoder/converter component configured to transcode/convert the live feed into a suitable format for broadcasting.

15. The system of claim 12, wherein the server further comprises a data store configured to store personal information provided during registration of a user associated with the at least one client device, and to store real-time location information of the at least one client device.

16. The system of claim 15, wherein the data store is configured to also store data collected and aggregated by the system.

17. The system of claim 12, wherein the server further comprises a mapping module configured to generate a digital representation of at least one geographical map.

18. The system of claim 12, further comprising at least one web server hosting one or more web sites.

19. The system of claim 18, wherein the one or more web sites include a supervisor-oriented website.

20. The system of claim 18, wherein the one or more web sites include a user-oriented website.

21. A web page comprising:
a. a map area including a graphical representation of a set of roads and of a location of an event of interest; and
b. a user profile area configured to dynamically display data associated with a user when a corresponding graphical representation of the user displayed in the map area is activated.

22. The web page of claim 21, wherein the user profile area includes a contact feature configured to provide communication with the user.

23. The web page of claim 21, wherein movement of the user in the real world corresponds to movement of the corresponding graphical representation of the user in the map area.

24. The web page of claim 21, further comprising a user interface configured to calibrate the map area.

25. The web page of claim 21, further comprising a radius selection interface configured to allow a viewer to select a radius such that a map of an area within the radius around the location of the event of interest is shown.

26. The web page of claim 21, further comprising a number-of-cars selection interface configured to allow a viewer to select a maximum value for a number of users that are displayed within the map area.

27. The web page of claim 26, wherein the number-of-cars selection interface is configured to allow the viewer to specify displaying criteria.
